(19) United States
(12) Patent Application Publication
(10) Pub. No.: US 2026/0241298 A1
(43) Pub. Date: Aug. 20, 2026

(54) METHOD AND DEVICE FOR SWITCHING WEAPON IN VIRTUAL GAME

(71) Applicant: NETEASE (HANGZHOU) NETWORK CO., LTD., Hangzhou, Zhejiang (CN)

(72) Inventor: Yangchen JIANG, Hangzhou, Zhejiang (CN)

(73) Assignee: NETEASE (HANGZHOU) NETWORK CO., LTD., Hangzhou, Zhejiang (CN)

(21) Appl. No.: 19/469,412

(22) PCT Filed: Aug. 7, 2023
(86) PCT No.: PCT/CN2023/111502

§ 371 Date: Sep. 26, 2025

(30) Foreign Application Priority Data
Mar. 27, 2023 (CN) 202310325638.1

(51) Int. Cl. A63F 13/837; A63F 13/52; A63F 13/533

(52) U.S. Cl. CPC A63F 13/837; A63F 13/52; A63F 13/533

(57) ABSTRACT

A method for switching a weapon in a virtual game includes: displaying on a graphical user interface a game interface corresponding to a virtual object controlled by a terminal device, the game interface displaying a switching control including a main control and at least two auxiliary controls distributed around the main control; in response to a switching operation in respect of the switching control, determining a target auxiliary control from amongst the at least two auxiliary controls, controlling a virtual weapon corresponding to the target auxiliary control to serve as the virtual weapon which is currently used by the virtual object, and controlling the main control to display a weapon identity of the virtual weapon corresponding to the target auxiliary control; and, in response to an attack operation, controlling the virtual object to control the currently-used virtual weapon so as to execute a game behavior.

### CROSS-REFERENCE TO RELATED APPLICATION

The present disclosure is a U.S. National Stage Application of International Application No. PCT/CN2023/111502, filed on Aug. 7, 2023, which is based upon and claims the priority to the Chinese Patent Application NO. 202310325638.1, entitled “METHOD AND DEVICE FOR SWITCHING WEAPON IN VIRTUAL GAME”, filed on Mar. 27, 2023, the entire contents of which are incorporated herein by reference for all purposes.

### TECHNICAL FIELD

The present disclosure relates to the field of game technologies, and in particular to a method and device for switching a weapon in a virtual game.

### BACKGROUND

In existing shooting games, weapon switching is usually pre-set in the games. When players enter the game, they are presented with a default battle layout that includes the weapon switching.

The weapon switching has high immediacy requirements and high operation frequency due to the operation frequency. The players are required to react quickly and make informed decisions based on the current battle situation to switch weapons in the intense and fast-paced gameplay. Therefore, the convenience and high degree of freedom in weapon switching are key demands for shooting game players.

### SUMMARY

According to an aspect of the present disclosure, there is provided a method for switching a weapon in a virtual game, wherein a graphical user interface is provided by a terminal device, and the method includes:
displaying, in the graphical user interface, a game interface corresponding to a virtual object controlled by the terminal device, wherein a switching control is displayed in the game interface, the switching control includes a main control and at least two auxiliary controls distributed around the main control, the main control is configured to display a weapon identity of a virtual weapon currently used by the virtual object, the at least two auxiliary controls each correspond to a virtual weapon and are configured to display a weapon attribute identity of the corresponding virtual weapon, and the currently used virtual weapon is one of virtual weapons respectively corresponding to the at least two auxiliary controls;
in response to a switching operation for the switching control, determining a target auxiliary control from the at least two auxiliary controls, controlling a virtual weapon corresponding to the target auxiliary control to be switched to the virtual weapon currently used by the virtual character, and controlling the main control to display a weapon identity of the virtual weapon corresponding to the target auxiliary control; and
in response to an attack operation, controlling the virtual object to control the currently used virtual weapon to perform a game action.

According to an aspect of the present disclosure, there is provided an electronic device, including a processor, a memory, and a computer program stored in the memory and capable of running on the processor, wherein the computer program, when executed by the processor, implements the method for switching the weapon in the virtual game as described above.

### BRIEF DESCRIPTION OF THE DRAWINGS

FIG. 1A is a flowchart of steps of a method for switching a weapon in a virtual game provided by an embodiment of the present disclosure;

FIG. 1B is a schematic diagram of a switching control provided by an embodiment of the present disclosure;

FIG. 2A is a flowchart of steps of another method for switching a weapon in a virtual game provided by an embodiment of the present disclosure;

FIG. 2B is a schematic diagram of another switching control provided by an embodiment of the present disclosure;

FIG. 2C is a schematic diagram of a switching operation provided by an embodiment of the present disclosure;

FIG. 2D is a schematic diagram of a graphical user interface provided by an embodiment of the present disclosure;

FIG. 2E is a schematic diagram of another graphical user interface provided by an embodiment of the present disclosure;

FIG. 3A is a flowchart of steps of another method for switching a weapon in a virtual game provided by an embodiment of the present disclosure;

FIG. 3B is a schematic diagram of a second game screen provided by an embodiment of the present disclosure;

FIG. 3C is a schematic diagram of another second game screen provided by an embodiment of the present disclosure;

FIG. 3D is a schematic diagram of yet another second game screen provided by an embodiment of the present disclosure;

FIG. 4A is a schematic diagram of a graphical user interface provided by an embodiment of the present disclosure;

FIG. 4B is a schematic diagram of another graphical user interface provided by an embodiment of the present disclosure; and

FIG. 5 is a schematic structural diagram of a device for switching a weapon in a virtual game provided by an embodiment of the present disclosure.

### DETAILED DESCRIPTION

To make the above objectives, features, and advantages of the present disclosure more clearly understood, the present disclosure is further described in detail below with reference to the accompanying drawings and specific embodiments. It is apparent that the embodiments described are only some of embodiments of the present disclosure, not all of them. All other embodiments derived by persons of ordinary skill in the art based on the embodiments of the present disclosure without inventive effort are also within the scope of protection of the present disclosure.

The following is an introduction to terms involved in embodiments of the present disclosure:
Virtual game: it can refer to a two-dimensional or three-dimensional game, and the virtual game can be games corresponding to game applications in terminals (mobile phones, PCs, cloud terminals, etc.).
Game interface: it is a terminal interface displayed (or provided) when an application runs a virtual game on a terminal (a mobile phone, a PC, a cloud, etc.), and the game interface can present a game scene and a control for a user to operate the game.
Virtual character: it refers to an image of a person or object that can interact with in a game scene, or an animated object within the game scene. This animated object can be a virtual person, virtual animal, or cartoon character. The virtual character may be a virtual image that represents the game user within the game scene.

The game scene may include multiple virtual characters, each of which has its own shape and volume in the game scene and occupies a portion of the space in the virtual scene. In team competition games, two or more virtual characters can form a game team in the game scene and compete with other game teams or individuals.

At present, virtual weapons possessed by a virtual character are usually displayed at the bottom center of a game interface. The virtual character can have two to three weapons, and the virtual weapons can be displayed in a horizontally tiled layout.

However, for this type of tiled display of virtual weapons, on the one hand, it is limited by a length of the interface and cannot display too many weapons; on the other hand, in the weapon switching operation, the large span between weapons results in low convenience in the weapon switching operation, making it difficult to switch quickly and prone to accidental touches during the operation.

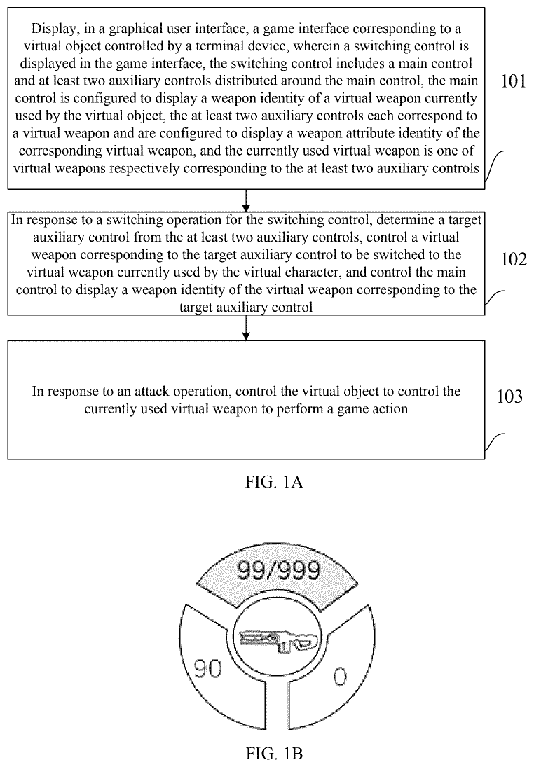

Reference is made to FIG. 1A, which shows a flowchart of steps of a method for switching a weapon in a virtual game provided by an embodiment of the present disclosure. A graphical user interface is provided by a terminal device, and the method may specifically include steps 101 to 103.

In the step 101, a game interface corresponding to a virtual object controlled by the terminal device is displayed in the graphical user interface, a switching control is displayed in the game interface, the switching control includes a main control and at least two auxiliary controls distributed around the main control, the main control is configured to display a weapon identity of a virtual weapon currently used by the virtual object, the at least two auxiliary controls each correspond to a virtual weapon and are configured to display a weapon attribute identity of the corresponding virtual weapon, and the currently used virtual weapon is one of virtual weapons respectively corresponding to the at least two auxiliary controls.

After a user launches a virtual game through the terminal device, the graphical user interface of the virtual game may be provided on the terminal device. The virtual character, that is, the virtual object, in the virtual game may possess two or more weapons, and the switching control may be displayed in the graphical user interface and may be used to switch the weapon currently used by the virtual character.

The switching control may include the main control and the at least two auxiliary controls distributed around the main control. For example, the switching control may be a wheel-style control. Each auxiliary control may correspond to a virtual weapon carried by the virtual character. Weapon types of virtual weapons may include but are not limited to firearms, artillery shells, arrows and other offensive virtual weapons in virtual games.

In an example, the main control can be set to a circle or other shapes. The main control can display the weapon identity, which can be a legend or a weapon name of the currently used weapon. In an example, the same weapon can have different legends in different configuration states, and thus the legend in the switching control can change in real time according to the actual configuration state of the currently used weapon.

In an example, the auxiliary controls can be provided as fan-shaped controls surrounding the circular main control, or can be provided as other shapes. The auxiliary controls can be divided into an auxiliary control corresponding to the virtual weapon being used by the virtual character and auxiliary controls corresponding to virtual weapons to be used which are possessed by the virtual character.

In an example, in the graphical user interface, the auxiliary control corresponding to the virtual weapon being used by the virtual character can be distinguished from the auxiliary controls corresponding to other virtual weapons to be used by adding a prominent element or adjusting the size of the auxiliary control (such as enlarging the auxiliary control) or the position of the auxiliary control (such as increasing a distance between the auxiliary control and the main control). The prominent element may include but is not limited to a brightness element, a color element, an identity element and other elements.

The auxiliary control may display the weapon attribute identity corresponding to the virtual weapon, such as ammunition information and attribute information. The ammunition information may include loadable magazine capacity information, current magazine remaining ammunition information, weapon remaining ammunition information, etc. The attribute information includes weapon accessory information (such as silencers, smoke suppressors, magazine types, and scopes), of the, as well as the virtual weapon's own attributes (e.g., firearms with electricity, firearms with fire). The accessory information may include a currently installed accessory in the weapon, a switchable accessory, etc. The auxiliary control can also display name information of the weapon, a legend of the weapon, or the like.

In actual applications, the switching control can be divided into different states. In different states, the switching control has different information in its auxiliary control. In actual applications, the content displayed in the auxiliary control of the switching control can be set according to actual needs.

In an example, during the game, the switching control can be adjusted in real time according to the weapon possessed by the virtual character. For example, when the virtual character possesses three weapons, the switching control can be set to present three auxiliary controls; and when the virtual character possesses four weapons, the switching control can be automatically adjusted from three auxiliary controls to four auxiliary controls.

As shown in FIG. 1B, this is a schematic diagram of a switching control in a graphical user interface of a virtual game. A center of the switching control is a circular main control, which displays the weapon legend of the virtual weapon currently used by the virtual character. Surrounding the main control are three fan-shaped auxiliary controls, which correspond to three virtual weapons A, B, and C carried by the virtual character, respectively. The ammunition information of the virtual weapons can be displayed in the fan-shaped auxiliary controls.

The fan-shaped auxiliary control located directly above is highlighted, which is an auxiliary control corresponding to the virtual weapon A currently used by the virtual character. The auxiliary control displays that there are 99 bullets in the magazine and the remaining bullets are 999.

An auxiliary control on the left is an auxiliary control corresponding to virtual weapon B to be used carried by the virtual character, and the auxiliary control displays the remaining ammunition count 90 of the virtual weapon.

An auxiliary control on the right is an auxiliary control corresponding to virtual weapon C to be used by the virtual character, and the auxiliary control displays the remaining ammunition count 0 of the virtual weapon.

In an example, when the ammunition of the virtual weapon is exhausted, a number for the remaining ammunition count may be displayed in a specific color (e.g., red).

By displaying the switching control in the game interface, the user can intuitively determine multiple weapons that the virtual character can use. Compared with the tiled display in the prior art, the switching control can save the display space, and intervals between weapons are reduced, thereby facilitating the weapon switching operation.

In the step 102, in response to a switching operation for the switching control, a target auxiliary control is determined from the at least two auxiliary controls, a virtual weapon corresponding to the target auxiliary control is controlled to be switched to the virtual weapon currently used by the virtual character, and the main control is controlled to display a weapon identity of the virtual weapon corresponding to the target auxiliary control.

The switching control in the graphical user interface can provide the user of the virtual game with a function of quickly switching the virtual weapon. When the user of the virtual game needs to switch the virtual weapon, a preset switching operation can be performed for the switching control, such as a single-click operation, a double-click operation, a long press operation, a sliding operation, etc. It should be noted that the switching operation is not limited to the above examples, and the user can set the switching operation according to actual needs.

The terminal device can determine the target auxiliary control from multiple auxiliary controls in response to the switching operation, and then replace the virtual weapon currently used by the user of the virtual game with the virtual weapon corresponding to the target auxiliary control, and also update the weapon identity displayed in the main control. Specifically, the weapon identity of the virtual weapon corresponding to the target auxiliary control is displayed in the main control.

In an embodiment of the present disclosure, when the switching operation is the double-click operation, the target auxiliary control is an auxiliary control corresponding to a virtual weapon determined according to a preset weapon switching rule.

The preset weapon switching rule can be a virtual weapon switching rule preset by the user of the virtual game, or a virtual weapon switching rule defaulted by the terminal system. The switching rule can be related to a priority of weapon use. For example, the user of the virtual game pre-sets the priority of weapon use as virtual weapon B>virtual weapon A>virtual weapon C. When the user of the virtual game has virtual weapon A, virtual weapon B, and virtual weapon C, in a case where the user of the virtual game is currently using virtual weapon A, the user of the virtual game double-clicks a switching button in the graphical user interface, and according to the weapon switching rule, virtual weapon A can be switched to virtual weapon B.

In another example, if the default weapon switching rule of the virtual game system is to switch to the virtual weapon that is most suitable for the current game scene, when the user of the virtual game double-clicks the switching control, the terminal device can determine the target auxiliary control that is most suitable for the current game scene from the multiple auxiliary controls in combination with the current game scene, and then execute the weapon switching when the virtual weapon currently used by the user of the virtual game is not the most suitable virtual weapon.

In yet another example, a preset switching order can also be to switch the weapon currently used by the user to the weapon the user switched to last time. For example, after the user switches weapon A to weapon B, when the user double-clicks the switching control, weapon B currently used by the virtual character will be automatically switched to weapon A.

The preset switching order can also be to switch the weapon currently used by the user to the most powerful weapon of the same type possessed by the user. For example, the virtual character is currently equipped with pistol A, and while exploring the game, picks up pistol B, which is more powerful than pistol A. In this case, the virtual character can be automatically equipped with weapon B by the user of the virtual game double-clicking the switching control.

It should be noted that the user of the virtual game can set the weapon switching order according to actual needs, which is not limited to the above examples.

In an embodiment of the present disclosure, the switching control can be used not only for switching the virtual weapon, but also for switching the weapon attribute of the virtual weapon. When the switching control is used for switching the attribute of the virtual weapon, a specific switching step is: in response to an attribute adjustment operation for the virtual weapon currently used by the virtual character based on the switching control, adjusting weapon attribute information of the virtual weapon; and
the weapon attribute information includes any one or more of: preset attribute information of the virtual weapon, and attribute information of the virtual weapon after being equipped with a weapon accessory.

The accessory of the virtual weapon may include but is not limited to a silencer, a smoke suppressor, a magazine, a scope and other accessories. The attribute information of the weapon accessory may include a status of the accessory (such as whether the scope is installed, whether the scope is active), a type of the accessory (such as a magazine type, a scope type). The attribute information of the weapon itself may refer to weapon attributes set for different weapon types in the virtual game, such as firearms with electricity, firearms with fire, etc.

In the step 103, in response to an attack operation, the virtual object is controlled to control the currently used virtual weapon to perform a game action.

After the switching of the virtual weapon is completed, the user can perform the attack operation in the virtual game, and the terminal device controls, in response to the attack operation, the virtual character in the virtual game to attack with the virtual weapon.

For example, when the virtual weapon is a firearm, the user can click a shooting button in the terminal device to perform the attack operation, and the terminal device can control, in response to the attack operation, the virtual object to perform the shooting action using the virtual weapon.

In embodiments of the present disclosure, the game interface corresponding to the virtual object controlled by the terminal device is displayed in the graphical user interface, and the switching control including the main control and the at least two auxiliary controls distributed around the main control is displayed in the game interface; in response to the switching operation for the switching control, the target auxiliary control is determined from the at least two auxiliary controls, the virtual weapon corresponding to the target auxiliary control is controlled to be switched to the virtual weapon currently used by the virtual character, and the main control is controlled to display the weapon identity of the virtual weapon corresponding to the target auxiliary control; and in response to the attack operation, the virtual object is controlled to control the currently used virtual weapon to perform the game action, thereby realizing the display of multiple virtual weapons of the virtual character in the game interface through the switching control, and the virtual weapons can be quickly switched through the switching control, thereby improving the weapon switching agility.

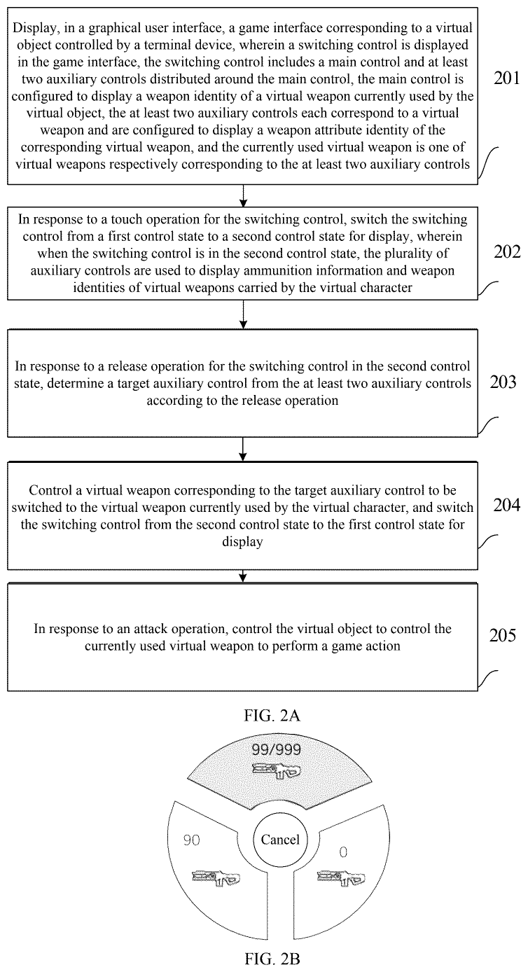

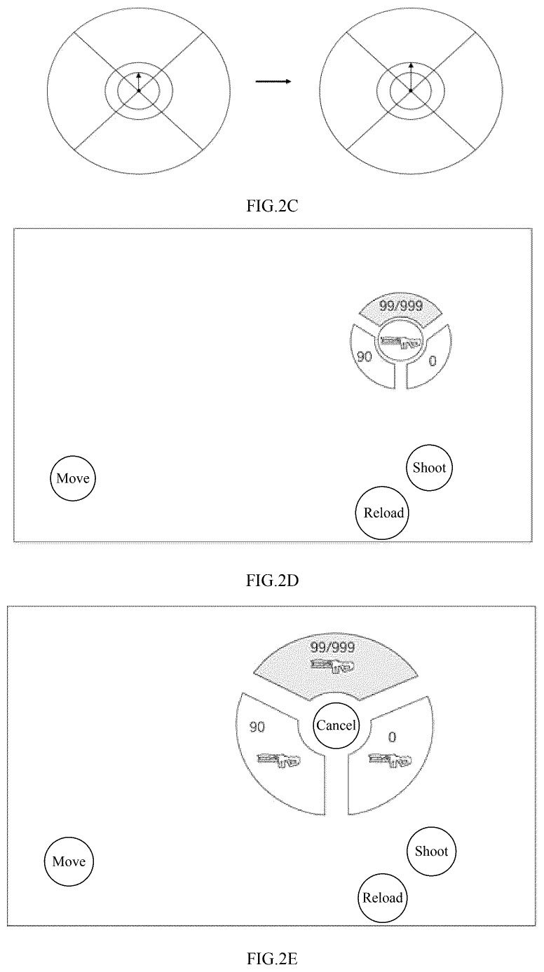

Reference is made to FIG. 2A, which shows a flowchart of steps of another method for switching a weapon in a virtual game provided by an embodiment of the present disclosure. The method may specifically include steps 201 to 205.

In the step 201, a game interface corresponding to a virtual object controlled by the terminal device is displayed in the graphical user interface, a switching control is displayed in the game interface, the switching control includes a main control and at least two auxiliary controls distributed around the main control, the main control is configured to display a weapon identity of a virtual weapon currently used by the virtual object, the at least two auxiliary controls each correspond to a virtual weapon and are configured to display a weapon attribute identity of the corresponding virtual weapon, and the currently used virtual weapon is one of virtual weapons respectively corresponding to the at least two auxiliary controls.

In the step 202, in response to a touch operation for the switching control, the switching control is switched from a first control state to a second control state for display, and when the switching control is in the second control state, the plurality of auxiliary controls are used to display ammunition information and a weapon identity of a virtual weapon carried by the virtual character.

States of the switching control can be divided into a first control state and a second control state, a distribution area of the first control state is smaller than a distribution area of the second control state, and the second control state can be used to display detailed information of weapons in multiple auxiliary controls to facilitate the user to select the weapon. The first control state is a normal display state of the switching control, that is, when the user does not operate the switching control, the switching control is displayed in the graphical user interface in the first control state.

The switching operation may include a touch operation and a release operation for the switching control. The touch operation is a virtual game control operation triggered by the user touching the switching control, and the release operation is an operation in which the user changes from touching the switching control to not touching the switching control.

During the virtual weapon switching, when the user performs the touch operation for the switching control, the switching control can be switched from the first control state to the second control state for display, so as to present more detailed weapon information to the user, such as the ammunition information and the weapon identity of the virtual weapon.

In the step 203, in response to a release operation for the switching control in the second control state, the target auxiliary control is determined from the at least two auxiliary controls according to the release operation.

When the release operation is performed for the switching control, the target auxiliary control can be determined based on the release operation. Specifically, the target auxiliary control can be determined based on an area where the release operation is performed. For example, when the user is within an effective area of auxiliary control 1 upon releasing the switching control after performing the switching operation, auxiliary control 1 can be used as the target auxiliary control.

In an embodiment of the present disclosure, when the switching control is in the second control state, the weapon identity, displayed by the main control, of the virtual weapon currently used by the virtual object is switched to a cancel control, and in response to the release operation acting on the cancel control, it is determined to cancel the switching operation for the currently used virtual weapon.

In actual applications, when the switching control is in the second control state, the main control may be the cancel control. When the release operation acts on the area where the cancel control is located, the current virtual weapon switching is canceled.

As shown in FIG. 2B, this is a schematic diagram of a switching control in a second control state. When the switching control is in the second control state, the switching control is proportionally enlarged from the first control state as a whole, the weapon identity in the main control is replaced by the cancel control, and the multiple auxiliary controls can display weapon details such as weapon identities in addition to displaying the ammunition information.

In an embodiment of the present disclosure, the switching operation further includes the sliding operation, which is an operation continuous with the touch operation, and the release operation is an operation continuous with the sliding operation. The sliding operation is an operation greater than a preset sliding threshold, and the preset sliding threshold is the minimum sliding distance from a first action position of the touch operation to a second action position responding to the release operation.

In actual applications, the switching operation is composed of multiple continuous operations, which may include the touch operation, the sliding operation and the release operation. The three operations are performed in the order of touch-sliding-release to realize the switching operation of the switching control.

The action position where the touch operation ends is a starting point of the sliding operation, and the action position of the release operation is an ending point of the sliding operation. A straight-line distance from the starting point to the ending point of the sliding operation is the sliding distance of the sliding operation.

The preset sliding threshold is the minimum sliding distance for implementing the switching operation for the target auxiliary control. The preset sliding thresholds of the multiple auxiliary controls can be the same or different. For example, the preset sliding thresholds can be arranged according to a historical switching frequency of each virtual weapon.

In response to the switching operation for the switching control, determining the target auxiliary control from the at least two auxiliary controls, and controlling the virtual weapon corresponding to the target auxiliary control to be switched to the virtual weapon currently used by the virtual character includes: when a touch operation for the switching control is detected, determining a first action position of the touch operation; determining whether the first action position is within a preset area of the main control, when the first action position is within the preset area, determining a sliding distance of a sliding operation, and determining whether the sliding distance is greater than a preset sliding threshold; and when it is determined that the sliding distance is greater than the sliding threshold, determining the target auxiliary control from the multiple auxiliary controls according to a sliding ending point, and controlling the virtual weapon corresponding to the target auxiliary control to be switched to the virtual weapon currently used by the virtual character.

In an embodiment of the present disclosure, the preset sliding threshold corresponding to each auxiliary control can be configured according to the switching frequency of the virtual weapon corresponding to the auxiliary control.

When the switching frequency of the virtual weapon is higher than a preset frequency, the virtual weapon is used frequently, and the preset sliding threshold can be set within a first preset range. When the switching frequency of the virtual weapon is not higher than the preset frequency, the preset sliding threshold can be set within a second preset range. The maximum value of the first preset range is less than or equal to the minimum value of the second preset range. For example, when a switching frequency of a certain virtual weapon is high, the weapon needs to be switched quickly, and its preset sliding distance is smaller, for example, the preset sliding distance is set to 50-80 px; and when a switching frequency of a certain virtual weapon is low and lower than the second preset range, a longer preset sliding distance can be set, for example, the preset sliding distance of the virtual weapon is set to exceed 80 px.

As shown in FIG. 2C, this is a schematic diagram of perform a switching operation for a switching control. As shown in FIG. 2C, the switching control is a circular wheel control. An area where a first circle from a center of the wheel control to outside is located can be set as a preset area for triggering the switching operation, and a point on a second circle from the center to outside can be set as a position closest to the preset area for triggering the virtual weapon switching.

When the user acts within the center circle, the action point can be set to the center of the center circle. When the user starts to slide, sliding from the action point to the first circle (a position shown on the left side of FIG. 2C), the user's release operation at this point cannot trigger the virtual weapon switching. When the user continues to slide to the point on the second circle (a position shown on the right side of FIG. 2C), the user's release operation at this point can trigger the virtual weapon switching. When the user does not perform the release operation when sliding to the point on the second circle, and continues to slide up a certain distance and then release, the virtual weapon switching can still be triggered.

The sliding distance shown on the right side of FIG. 2C is the minimum sliding distance of the sliding operation, and the minimum sliding distance is used as the preset sliding threshold to determine whether the user operation can trigger the virtual weapon switching.

In the step 204, the virtual weapon corresponding to the target auxiliary control is controlled to be switched to the virtual weapon currently used by the virtual character, and the switching control is switched from the second control state to the first control state for display.

After the user performs the release operation, the terminal device can control the virtual character to switch the weapon, and after the weapon switching ends, the switching control can be switched from the second control state to the first control state.

In the step 205, in response to an attack operation, the virtual object is controlled to control the currently used virtual weapon to perform a game action.

In an embodiment of the present disclosure, the switching control can also trigger reloading. A reloading method is: when the touch operation for the switching control is detected, in response to a touch duration of the touch operation being less than a first time threshold, reloading is performed for one or more virtual weapons corresponding to the multiple auxiliary controls.

The user can set the reloading according to actual needs. For example, when the user single-clicks the main control of the switching control, the reloading is performed for the currently used virtual weapon or all the virtual weapons possessed by the virtual character. For another example, when the user single-clicks a certain auxiliary control of the switching control, the reloading is performed for the virtual weapon corresponding to the auxiliary control.

In actual applications, after the reloading is performed, ammunition information of each virtual weapon in the switching control is updated accordingly.

In an embodiment of the present disclosure, the switching control can also integrated with the layout setting triggering corresponding to the switching control to realize a fast layout switching control. The method includes: in response to the touch duration of the touch operation being greater than a second time threshold, determining to trigger a first adjustment operation for the switching control, and the second time threshold is greater than the first time threshold.

The first adjustment operation is an operation for starting a switching control setting mode. When the first adjustment operation is triggered, the graphical user interface can be controlled, in response to the first adjustment operation for the switching control, to display a second game screen corresponding to the switching control, and the second game screen is a setting interface for the switching control.

In an embodiment of the present disclosure, the specific process of the step 202 and the step 203 is: in response to the touch duration of the touch operation being greater than the first time threshold and a sliding operation performed continuously after the touch operation, during the sliding operation, the switching control is switched from the first control state to the second control state for display, and after the release operation, the virtual weapon corresponding to the target auxiliary control is controlled to be switched to the virtual weapon currently used by the virtual character.

It should be noted that the first time threshold and the second time threshold can be set according to user needs and are not subject to excessive restrictions here.

The above process is illustratively described below with reference to FIG. 2D and FIG. 2E.

FIG. 2D is a schematic diagram of a graphical user interface when a switching control is in a first control state. The graphical user interface can display a movement control, a reloading control, a shooting control, and a switching control in the first control state. The movement control is used to control the movement of the virtual character in the game scene, the reloading control is used to replenish ammunition for a firearm-type weapon possessed by the virtual character, and the shooting control is used to control the virtual character to use the virtual weapon to perform an attack operation.

When the user performs the switching operation for the switching control in the first control state in FIG. 2D, and the touch duration of the user's touch operation for the main control is greater than the second time threshold (e.g., the second time threshold is 0.2 seconds), the control state of the switching control changes from the first control state to the second control state, and thus the graphical user interface is switched from FIG. 2D to FIG. 2E. FIG. 2E is a schematic diagram of a graphical user interface when a switching control is in a second control state, and the movement control, the reloading control, the shooting control and the switching control in the second control state can be displayed on the graphical user interface.

When the switching control is in the second control state, the distribution area of the switching control becomes larger. The main control displays a cancel button for canceling the weapon switching, and external auxiliary controls surrounding the main control extend outward to enlarge the distribution area of the auxiliary controls. In addition to displaying the ammunition information displayed in the first control state, the auxiliary control can also display the weapon legend of the weapon corresponding to the auxiliary control.

After the touch operation, the user continues to slide from the main control to the auxiliary control surrounding the main control, and performs the release operation, that is, the user releases the switching control, then the weapon currently used by the virtual character can be switched to the weapon corresponding to the auxiliary control. In addition, after the user releases the switching control, the control state of the switching control is switched from the second control state to the first control state.

When the user slides to the auxiliary control according to the sliding operation and does not release it, but continues to slide from the auxiliary control to the cancel button of the main control and then releases it, the weapon switching will not be performed, and after the user releases it, the switching control is switched from the second control state to the first control state.

In embodiments of the present disclosure, when the touch operation is performed for the switching control, the switching control is switched from the first control state to the second control state, which is convenient for the user to view details of the virtual weapon being carried and in turn facilitates the weapon switching. During the touch phase, the switching control is switched to the second control state, displaying weapon details to assist the user in switching the weapon. During the release phase, the switching control is returned to the first control state, avoiding the switching control occupying excessive interface and improving the user's gaming experience.

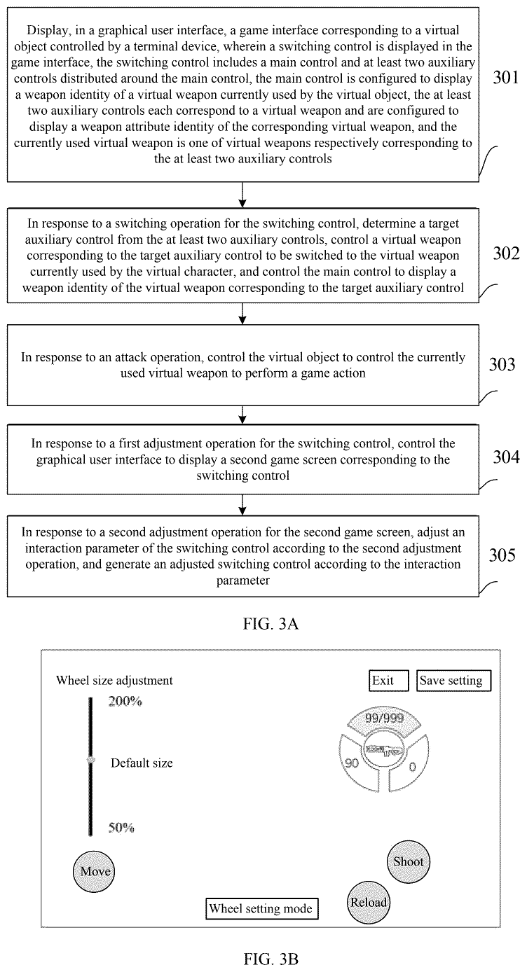

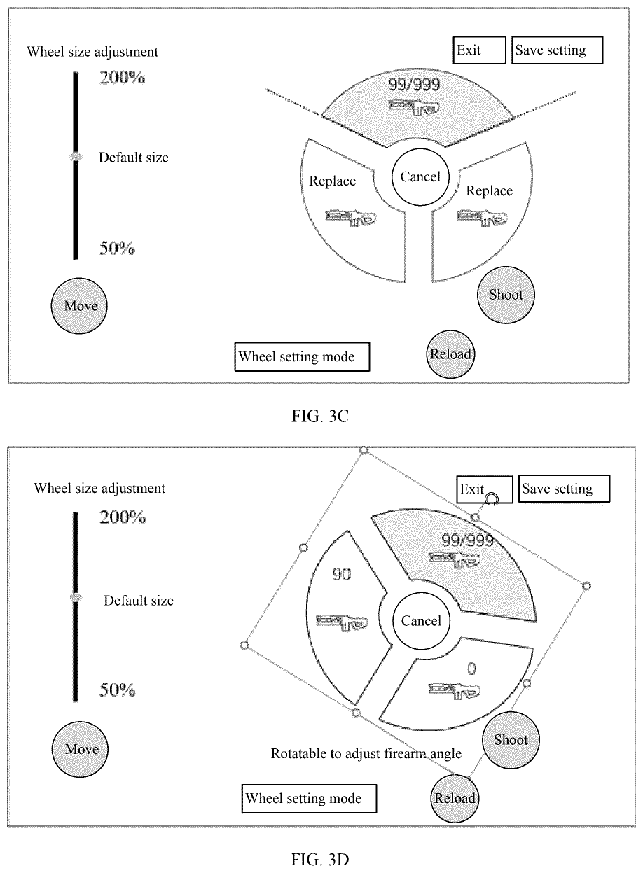

Reference is made to FIG. 3A, which shows a flowchart of steps of another method for switching a weapon in a virtual game provided by an embodiment of the present disclosure. The method may specifically include steps 301 to 305.

In the step 301, a game interface corresponding to a virtual object controlled by the terminal device is displayed in the graphical user interface, a switching control is displayed in the game interface, the switching control includes a main control and at least two auxiliary controls distributed around the main control, the main control is configured to display a weapon identity of a virtual weapon currently used by the virtual object, the at least two auxiliary controls each correspond to a virtual weapon and are configured to display a weapon attribute identity of the corresponding virtual weapon, and the currently used virtual weapon is one of virtual weapons respectively corresponding to the at least two auxiliary controls.

In the step 302, in response to a switching operation for the switching control, a target auxiliary control is determined from the at least two auxiliary controls, a virtual weapon corresponding to the target auxiliary control is controlled to be switched to the virtual weapon currently used by the virtual character, and the main control is controlled to display a weapon identity of the virtual weapon corresponding to the target auxiliary control.

In the step 303, in response to an attack operation, the virtual object is controlled to control the currently used virtual weapon to perform a game action.

In the step 304, in response to a first adjustment operation for the switching control, the graphical user interface is controlled to display a second game screen corresponding to the switching control.

The first adjustment operation is an operation to trigger a switching control setting interface, and the first adjustment operation can be specifically a single-click operation, a press operation, etc. For example, after the switching control is continuously pressed for 3 seconds, the switching control setting interface is entered.

When the user of the virtual game performs the first adjustment operation for the switching control, the terminal device displays the second game screen in the graphical user interface in response to the first adjustment operation, and the second game screen is a game interface for setting the switching control.

In the step 305, in response to a second adjustment operation for the second game screen, an interaction parameter of the switching control is adjusted according to the second adjustment operation, and an adjusted switching control is generated according to the interaction parameter, the interaction parameters include at least one of a display parameter or a response parameter.

In the second game screen, when the user performs the second adjustment operation, the interaction parameter of the switching control can be adjusted according to the second adjustment operation, and the adjusted switching control can be generated.

In an embodiment of the present disclosure, the second game screen is overlaid on the game interface with a preset transparency, so that the distribution of other controls of the game interface except the switching control can be determined through the second game screen, and in the second game screen, other controls in the game interface are in an unavailable state.

In an embodiment of the present disclosure, an exit control for the second game screen is displayed in the second game screen, and the method further includes: in response to a confirmation operation for the exit control, controlling the graphical user interface to hide the second game screen and display the game interface.

The confirmation operation can be any one of a click operation and a long press operation for the exit control. It should be noted that the confirmation operation is not limited to the above examples, and the user can set the confirmation operation according to actual needs.

In an embodiment of the present disclosure, a save control for the adjustment made for the switching control is displayed in the second game screen, and the method further includes: in response to a confirmation operation for the save control, controlling the graphical user interface to save the adjustment made for the switching control.

The confirmation operation can be any one of a click operation and a long press operation for the exit control. It should be noted that the confirmation operation is not limited to the above examples, and the user can set the confirmation operation according to actual needs.

In an embodiment of the present disclosure, a size adjustment control for adjusting a size of the switching control is displayed in the second game screen, and the method further includes: in the second game screen, in response to a size adjustment operation for the size adjustment control, adjusting the size of the switching control according to the size adjustment operation.

In actual applications, in the second game screen, the size adjustment control is used to adjust the size of the switching control on the graphical user interface. In the second game screen, the user acts on the size adjustment control to achieve the scaling adjustment of the size of the switching control.

In an embodiment of the present disclosure, the method further includes: in the second game screen, in response to a position adjustment operation for the switching control, adjusting a position of the switching control.

In the second game screen, the position adjustment operation can be performed for the switching control, and the position adjustment operation can be that in the second game screen, the switching control is selected, and the position of the switching control is dragged to a suitable area.

In an embodiment of the present disclosure, the method further includes: in the second game screen, in response to a click operation for the main control, switching the switching control from the first control state to the second control state for display.

In an embodiment of the present disclosure, the method further includes: in the second game screen, in response to a rotation operation for the switching control, adjusting angle information of the switching control, and maintaining weapon identities and ammunition information in the multiple auxiliary controls in a preset direction.

In actual applications, in the second game screen, the rotation operation can be performed for the switching control to adjust the angle of the switching control. After the angle is rotated, the weapon identity displayed in the auxiliary control can still maintain the preset direction.

In an embodiment of the present disclosure, the method further includes: in the second game screen, in response to a click operation for a first target auxiliary control, highlighting the first target auxiliary control, and switching ammunition information in another auxiliary control to a replacement control; and in response to a click operation for a target replacement control, exchanging a position of an auxiliary control corresponding to the target replacement control with a position of the first target auxiliary control.

In actual applications, when the user clicks on the target auxiliary control, the target auxiliary control can be selected, and the replacement control can be presented in other unselected auxiliary controls in the switching control. When the user performs a replacement operation for the target replacement control, the position of the target auxiliary control and the position of the auxiliary control corresponding to the target replacement control are exchanged.

In an example, when the user selects the target auxiliary control, the prominent element may be added to the target auxiliary control. The prominent element may include a brightness element, a color element, an identity element, and the like.

In an embodiment of the present disclosure, the method further includes: in the second game screen, in response to a click operation for the first target auxiliary control, highlighting an area adjustment reference line of the first target auxiliary control; and in response to an adjustment operation for the area adjustment reference line, adjusting the distribution area of the first target auxiliary control.

In actual applications, in the second game screen, the distribution area of auxiliary control may also be adjusted.

The larger the area of the target auxiliary control, the higher the success rate of switching, which can support more frequent switching operations. By adjusting the area of the weapon, help can be provided to the player in specific gameplay situations where the use of certain firearms is restricted or certain firearms are used infrequently. In addition, by adjusting the switching angle, the switching efficiency of other weapons can be improved. In actual applications, real-time dynamic adjustments can be made based on player needs and player mechanics.

The switching control adjustment operation when the switching control is in the setting mode is illustratively described with reference to FIG. 3B to FIG. 3D.

When the user presses the switching control for 3 seconds without releasing it, the switching control can enter a wheel setting mode, as shown in FIG. 3B.

After this mode is entered, in the game interface, the transparency of interactive buttons (such as the movement button, the shooting button, and the reloading button) except for the switching control is reduced, in order to make the wheel setting clearer and more convenient.

In the wheel setting mode, the second game interface can display an exit button and a setting save button. When the user clicks the exit button, the second game interface can be exited and returned to the first game interface. When the user clicks the setting save button, the current adjustment for the switching control can be saved and applied to the first game interface.

In this mode, a wheel size adjustment scroll bar may be displayed in the second game screen for adjusting the wheel size. When the user slides the scroll bar, the wheel size is adjusted.

In FIG. 3B, when the switching control is selected, the user can adjust the position of the switching control in the graphical user interface by dragging the selected switching control.

When the switching control is clicked, the switching control is switched from the first control state to the second control state, as shown in FIG. 3C. The main control is clicked to select the entire switching control, and the switching control can be rotated to adjust to any viewing angle.

The auxiliary control is clicked to select the target auxiliary control, as shown in FIG. 3C. In this case, the selected target auxiliary control is highlighted and the adjustment auxiliary line is displayed, while the replacement control is displayed in the unselected auxiliary control in the switching control. When the user clicks the target replacement button, the auxiliary control position is replaced. When the user drags the adjustment auxiliary line, the distribution area of the target auxiliary control can be adjusted.

As shown in FIG. 3D, in the wheel mode, when the switching control is in the second control state, the switching control can be selected and rotated. After the angle of the switching control is adjusted, the virtual weapon icon and the ammunition information in the auxiliary control and the cancel button in the main control can maintain the preset angle.

In embodiments of the present disclosure, in the virtual game, a setting mode of the switching control can be quickly entered through the switching control, so as to facilitate the adjustment of the graphical user interface layout of the switching control.

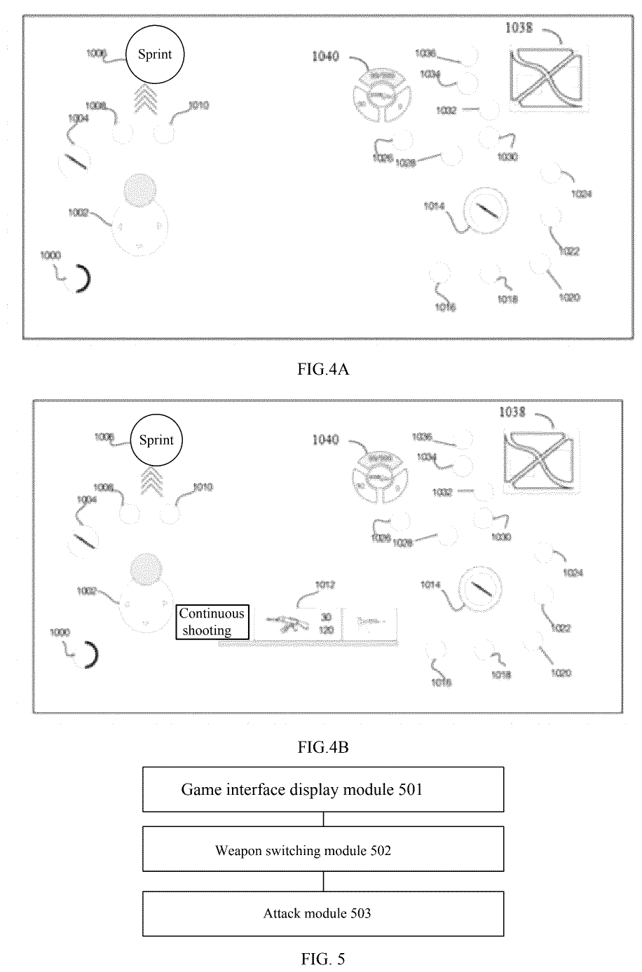

The following provides an application scenario for an embodiment of the present disclosure. FIG. 4A shows a schematic diagram of a graphical user interface. The interface includes a game scene and a virtual object located in the game scene, which are not shown in FIG. 4A. The player controls the virtual object to move within the game scene. The interface in FIG. 4A shows various controls, which are displayed in the game scene.

1000 represents a backpack control. The display of a backpack interface in the graphical user interface is triggered by a touch operation acting on this control, and the backpack interface is used to view the backpack's items, which may include, but are not limited to, medicine, weapons, accessories, and armor. In an embodiment, an edge of the backpack control is provided with an edge line to indicate the amount of items in the backpack. The touch operation acting on the backpack control can be a click operation, a double-click operation, a long press operation, a sliding operation, etc.

1002 is a movement control, and a circle filled with shadow is a joystick in the movement control. In an embodiment, the movement control is configured with a movement response area, and the movement response area can be the same size as the movement control, that is, an area in the graphical user interface corresponding to the movement control is the movement response area. In an embodiment, the size of the movement response area can be larger than the size of the movement control, that is, the movement control is provided in the movement response area. In terms of distance, the graphical user interface is divided into left and right areas from the middle, where the left area is the movement response area of the movement control. The movement control instruction is triggered by the touch operation acting on the movement response area of the movement control, and the movement direction of the virtual object is controlled according to the movement control instruction. The touch operation acting on the movement response area of the movement control can be a click operation, a double-click operation, a long press operation, a sliding operation, etc.

When it is detected that the touch operation triggering the movement control instruction meets a preset condition, a “sprint” instruction is triggered, causing the virtual object to automatically and continuously run within the game scene. As shown in FIG. 4A, in an embodiment, the touch operation triggering the movement control instruction meeting the preset condition is that a touch operation applied to a joystick area is slid in a preset direction to a preset distance or preset area (e.g., a position indicated by the arrow above the joystick). For example, when the touch operation drags the joystick upward, a sprint control 1006 appears. When this sprint control is triggered, the virtual object enters a fast running mode. In addition, control 1030 is also a sprint control. When the control 1030 is clicked, the virtual object enters the fast running mode. In an embodiment, the touch operation triggering the movement control instruction meeting the preset condition is that the touch operation applied to the joystick area meets a preset duration, or meets a preset pressure, etc.

1004 and 1014 are both attack controls. An attack instruction is triggered by a touch operation acting on an attack response area of the attack control, and the virtual character is controlled, according to the attack instruction, to execute an attack operation in the game scene. An attack action triggered by the attack control corresponds to the current equipped state of the virtual object. For example, when the virtual object is equipped with a ranged weapon, the attack action triggered by the attack control is a shooting action. That is, the left hand can trigger the control 1004 to execute a shooting operation, while the right hand can trigger the control 1014 to execute a shooting operation. When the virtual character is equipped with a melee weapon, the attack action triggered by the attack control is a slashing action, etc. In an embodiment, only one of the attack controls 1004 and 1014 is displayed. A display position of the attack control can be adjusted based on a position setting instruction, which can be triggered in the setting interface or during the match. The touch operation acting on the attack control can be a click operation, a double-click operation, a long press operation, a sliding operation, etc.

1008 and 1010 are posture controls. A posture adjustment instruction is triggered by a touch operation acting on the posture control to adjust the virtual object's posture in the game scene. Triggering the control 1008 can control the weapon to be in the virtual object's left arm position, and control the virtual object to stand with its head turned to the left. Triggering the control 1010 can control the weapon to be in the virtual object's right arm position, and control the virtual object to stand with its head turned to the right. The controls 1008 and 1010 are primarily used to control the virtual object's posture when it's hiding behind obstacles like walls and trees. The touch operation acting on the posture control can be a click operation, a double-click operation, a long press operation, a sliding operation, etc.

In addition, the control 1016 is a reloading control. Triggering the reloading control may add bullets to the currently used weapon. After reloading, the bullet count is at its maximum. The touch operation acting on the weapon slot can be a click operation, a double-click operation, a long press operation, a sliding operation, etc.

Controls 1018 and 1020 are action controls. A touch operation acting on the action control controls the virtual object to perform corresponding actions in the game scene. For example, triggering the control 1018 can cause the virtual object to crouch, while triggering the control 1020 can cause the virtual object to lie prone. Control 1022 can cause the virtual object to jump. The touch operation acting on the action control can be a click operation, a double-click operation, a long press operation, a sliding operation, etc.

Control 1024 is used to control the current game scene to enter a scope mode (also referred to as an Aim Down Sights (ADS) mode). When a first touch operation acting on the control 1024 is detected, the game scene is controlled to enter the scope mode. In the scope mode, a scope view is displayed in the game scene, and a game scene as seen through the scope view by the virtual object is also displayed. The shooting accuracy can be improved in the scope mode. When a second touch operation acting on control 1024 is detected, the game scene is controlled to exit the scope mode. In an embodiment, the first and second touch operations are independent touch operations. For example, the control 1024 is clicked to control the current game scene to enter the scope mode, and the control 1024 is clicked again to exit the scope mode, re-displaying the game scene which is captured by the virtual camera when following the virtual object. In an embodiment, the first and second touch operations can be starting and ending operations of a single touch operation. For example, when it is detected that the control 1024 is touched, the game scene is controlled to enter the scope mode. During the continuous press, the game scene is controlled to be in the scope mode continuously. When the touch triggering the touch operation is detected to leave the touch detection area, the scope mode is exited.

The control 1026 is used to control a shooting parameter of a virtual camera presenting the game screen, thereby adjusting the field of view of the game scene displayed in the graphical user interface. In an embodiment, it is determined that a touch operation acting on the control 1026 is detected, and the shooting parameter of the virtual camera is adjusted based on the touch operation. The shooting parameter includes but is not limited to the position, orientation, and viewing angle of the virtual camera. The touch operation acting on the control 1026 can be a click operation, a double-click operation, a long press operation, a sliding operation, etc.

The control 1028 is a marking control. Virtual subjects, virtual objects, etc. in the game scene are marked through a touch operation acting on the marking control. The control 1032 is a setting control. The control 1032 is clicked to display a setting menu for setting a basic function of the current game. The touch operation acting on the control 1028 can be a click operation, a double-click operation, a long press operation, a sliding operation, etc.

Controls 1034 and 1036 are message controls, where the control 1034 can be used to view a system notification, and the control 1036 can be used to view a message sent by a teammate or send a message to the teammate. 1038 is a mini-map for displaying a position of the virtual object controlled by the player, and displaying positions of virtual objects of some other players.

1040 is the switching control in embodiments of the present disclosure, which is used by the user to switch the virtual weapon currently used by the virtual character. The switching control is composed of a main control and multiple auxiliary controls distributed around the main control. The main control can display the weapon legend of the weapon currently used by the user, and the multiple auxiliary controls can display the ammunition information of the weapon.

Based on the above application scenarios, the player can execute the method for switching the weapon in the virtual game in this embodiment through the switching control 1040.

In another application scenario, as shown in FIG. 4B, in addition to the controls described in FIG. 4A, the graphical user interface may also include a control 1012, which represents a weapon slot. Triggering the weapon slot can switch the weapon used by the player. The “continuous shooting” on the left indicates a current shooting mode. In a “continuous shooting” mode, multiple bullets are fired continuously. In addition to the “continuous shooting” mode, a “single shooting” mode can also be switched to. In the “single shooting” mode, a single bullet is fired. The shaded bar below is used to indicate the bullet count in the weapon. During the shooting, the bullet count decreases. When the bullet count reaches zero, the automatic reloading can be performed, at which point the bullet count is at its maximum.

It should be noted that for the method embodiments, for the sake of simplicity, they are expressed as a series of action combinations, but those skilled in the art should be aware that embodiments of the present disclosure are not limited by the order of the actions described, because according to the embodiments of the present disclosure, certain steps can be performed in other orders or simultaneously. Secondly, those skilled in the art should also be aware that the embodiments described in the specification are all preferred embodiments, and the actions involved are not necessarily required by the embodiments of the present disclosure.

Reference is made to FIG. 5, which shows a schematic structural diagram of a device for switching a weapon in a virtual game provided by an embodiment of the present disclosure. The device may specifically include the following modules:
a game interface display module 501, configured to display, in the graphical user interface, a game interface corresponding to a virtual object controlled by the terminal device, wherein a switching control is displayed in the game interface, the switching control includes a main control and at least two auxiliary controls distributed around the main control, the main control is configured to display a weapon identity of a virtual weapon currently used by the virtual object, the at least two auxiliary controls each correspond to a virtual weapon and are configured to display a weapon attribute identity of the corresponding virtual weapon, and the currently used virtual weapon is one of virtual weapons respectively corresponding to the at least two auxiliary controls; a weapon switching module 502, configured to, in response to a switching operation for the switching control, determine a target auxiliary control from the at least two auxiliary controls, control a virtual weapon corresponding to the target auxiliary control to be switched to the virtual weapon currently used by the virtual character, and control the main control to display a weapon identity of the virtual weapon corresponding to the target auxiliary control; and an attack module 503, configured to, in response to an attack operation, control the virtual object to control the currently used virtual weapon to perform a game action.

In this embodiment, the display of multiple virtual weapons of the virtual character is realized in the game interface through the switching control, and the virtual weapons can be quickly switched through the switching control, thereby improving the weapon switching agility.

In an embodiment of the present disclosure, the switching operation includes a touch operation and a release operation for the switching control, and the weapon switching module 502 includes: a control state switching display sub-module, configured to, in response to the touch operation for the switching control, switch the switching control from a first control state to a second control state for display, wherein when the switching control is in the second control state, the plurality of auxiliary controls are used to display ammunition information and weapon identities of virtual weapons carried by the virtual character; a target auxiliary control determination sub-module, configured to, in response to the release operation for the switching control in the second control state, determine the target auxiliary control from the at least two auxiliary controls according to the release operation; and a weapon switching sub-module, configured to control the virtual weapon corresponding to the target auxiliary control to be switched to the virtual weapon currently used by the virtual character, and switch the switching control from the second control state to the first control state for display.

In embodiments of the present disclosure, when the touch operation is performed for the switching control, the switching control is switched from the first control state to the second control state, which is convenient for the user to view details of the virtual weapon being carried and in turn facilitates the weapon switching. During the touch phase, the switching control is switched to the second control state, displaying weapon details to assist the user in switching the weapon. During the release phase, the switching control is returned to the first control state, avoiding the switching control occupying excessive interface and improving the user's gaming experience.

In an embodiment of the present disclosure, the device further includes: a cancel control display sub-module, configured to, when the switching control is in the second control state, switch the weapon identity, displayed by the main control, of the virtual weapon currently used by the virtual object to a cancel control; and a cancel switching sub-module, configured to, in response to the release operation acting on the cancel control, determine to cancel a switching operation for the currently used virtual weapon.

By switching the weapon identity, displayed by the main control, of the virtual weapon currently used by the virtual object to the cancel control and making the release operation act on the cancel control, the virtual weapon switching operation can be canceled, making it easier for the player to adjust the virtual weapon in real time.

In an embodiment of the present disclosure, the switching operation further includes a sliding operation, the sliding operation is an operation continuous with the touch operation, the release operation is an operation continuous with the sliding operation, the sliding operation is an operation greater than a preset sliding threshold, and the preset sliding threshold is a minimum sliding distance from a first action position of the touch operation to a second action position responding to the release operation.

In this embodiment, the switching operation is composed of multiple continuous operations, which may include the touch operation, the sliding operation and the release operation. The three operations are performed in the order of touch-sliding-release to realize the switching operation of the switching control. The virtual weapons can be quickly switched through the switching control, which improves the weapon switching agility.

In an embodiment of the present disclosure, a preset sliding threshold corresponding to each auxiliary control is configured according to a switching frequency of a virtual weapon corresponding to the auxiliary control.

When a switching frequency of a certain virtual weapon is high, the weapon needs to be switched quickly and its preset sliding distance is short. Conversely, when a switching frequency of a certain virtual weapon is low and below the second preset range, a longer preset sliding distance can be set. Generally, virtual weapons with high switching frequencies are virtual weapons frequently used by the player. Therefore, this process makes it easy for the player to quickly switch to frequently used virtual weapons, further realizing the rapid virtual weapon switching.

In an embodiment of the present disclosure, the device further includes:
a weapon attribute adjustment module, configured to, in response to an attribute adjustment operation for the virtual weapon currently used by the virtual character based on the switching control, adjust weapon attribute information of the virtual weapon; and the weapon attribute information includes any one or more of: preset attribute information of the virtual weapon and attribute information of the virtual weapon after being equipped with a weapon accessory.

In this embodiment, the weapon attribute information of the virtual weapon can also be adjusted through the switching control, so that the user can strengthen the virtual weapon through the weapon attribute information adjustment, which is convenient for the user to better play the game and simplify the operation.

In an embodiment of the present disclosure, when the switching operation is a double-click operation, the target auxiliary control is an auxiliary control corresponding to a virtual weapon determined according to a preset weapon switching rule.

By presetting the weapon switching rule, players no longer need to click on the corresponding virtual weapons separately. Instead, they only need to double-click multiple times to switch virtual weapons in sequence, thereby improving the weapon switching smoothness.

In an embodiment of the present disclosure, the device further includes: a reloading trigger module, configured to, when the touch operation for the switching control is detected, in response to a touch duration of the touch operation being less than a first time threshold, reload one or more virtual weapons corresponding to the plurality of auxiliary controls; a first adjustment trigger module, configured to, in response to the touch duration of the touch operation being greater than a second time threshold, determine to trigger a first adjustment operation for the switching control, wherein the second time threshold is greater than the first time threshold; and a weapon switching trigger module, configured to, in response to a sliding operation performed continuously after the touch operation when the touch duration of the touch operation is greater than the first time threshold, switch the switching control from the first control state to the second control state for display during the sliding operation, and control the virtual weapon corresponding to the target auxiliary control to be switched to the virtual weapon currently used by the virtual character after the release operation.

Through triggering different operations, respectively, by detecting the touch duration of the touch operation for the switching control, the technical problem of occupying a large space caused by implementing different functions through different controls can be avoided. This process can implement multiple different functions through one switching control, thereby improving the utilization rate of the interactive interface.

In an embodiment of the present disclosure, the device further includes: a first adjustment operation response module, configured to, in response to a first adjustment operation for the switching control, control the graphical user interface to display a second game screen corresponding to the switching control; and a second adjustment operation response module, configured to, in response to a second adjustment operation for the second game screen, adjust an interaction parameter of the switching control according to the second adjustment operation, and generate an adjusted switching control according to the interaction parameter, wherein the interaction parameter includes at least one of: a display parameter or a response parameter.

In an embodiment of the present disclosure, the second game screen is overlaid on the game interface with a preset transparency, distribution of other controls of the game interface except the switching control is determined through the second game screen, and the other controls in the game interface are in an unavailable state in the second game screen.

In an embodiment of the present disclosure, an exit control for the second game screen is displayed in the second game screen, and the device further includes: an exit control response module, configured to, in response to a confirmation operation for the exit control, control the graphical user interface to hide the second game screen and display the game interface.

A save control for adjustment made for the switching control is displayed in the second game screen, and the method further includes: in response to a confirmation operation for the save control, controlling the graphical user interface to save the adjustment made for the switching control.

In this embodiment, the user's adjustment to the second game screen can be saved through the save control, so that the game screen can be adjusted quickly and efficiently next time.

In an embodiment of the present disclosure, a size adjustment control for adjusting a size of the switching control is displayed in the second game screen, and the device further includes: a size adjustment module, configured to, in response to a size adjustment operation for the size adjustment control in the second game screen, adjust the size of the switching control according to the size adjustment operation.

In this embodiment, the size adjustment operation of the size adjustment control can adjust the size of the switching control in real time to adapt to different user needs, making it easier for players to adjust the size in real time based on their usage habits, further improving the user's gaming experience. Furthermore, the larger the area of the target auxiliary control, the higher the success rate of switching, which can support more frequent switching operations.

In an embodiment of the present disclosure, the device further includes: a position adjustment module, configured to, in response to a position adjustment operation for the switching control in the second game screen, adjust a position of the switching control.

In this embodiment, the position of the switching control is adjusted by performing the position adjustment operation for the switching control, so that the user can adjust the position of the switching control based on his or her own usage habits, thereby further improving the user's gaming experience.

In an embodiment of the present disclosure, the device further includes: a control state switching module, configured to, in response to a click operation for the main control in the second game screen, switch the switching control from a first control state to a second control state for display.

In this embodiment, by clicking on the main control, the switching control can be quickly switched from the first control state to the second control state for display, so that players can timely understand the current usage of virtual weapons and further enhance the user's gaming experience.

In an embodiment of the present disclosure, the device further includes: a switching control angle adjustment module, configured to, in response to a rotation operation for the switching control in the second game screen, adjust angle information of the switching control, and maintain weapon identities and ammunition information in the plurality of auxiliary controls in a preset direction.

In this embodiment, by adjusting the switching angle, the switching efficiency of other weapons can be improved. In actual application, real-time dynamic adjustment can be made according to the player needs and player mechanism to further enhance the user's gaming experience.

In an embodiment of the present disclosure, the device further includes: a replacement control display module, configured to, in response to a click operation for a first target auxiliary control in the second game screen, highlight the first target auxiliary control, and switch ammunition information in another auxiliary control to a replacement control; and an auxiliary control position exchanging module, configured to, in response to a click operation for a target replacement control, exchange a position of an auxiliary control corresponding to the target replacement control with a position of the first target auxiliary control.

In actual applications, when the user clicks on the target auxiliary control, the target auxiliary control can be selected, and the replacement control can be presented in other unselected auxiliary controls in the switching control. When the user performs a replacement operation for the target replacement control, the position of the target auxiliary control and the position of the auxiliary control corresponding to the target replacement control are exchanged.

In an embodiment of the present disclosure, the device further includes: an auxiliary line display module, configured to, in response to a click operation for a first target auxiliary control in the second game screen, highlight an area adjustment reference line of the first target auxiliary control; and an auxiliary control difference distribution adjustment module, configured to, in response to an adjustment operation for the area adjustment reference line, adjust distribution area of the first target auxiliary control.

The larger the area of the target auxiliary control, the higher the success rate of switching, which can support more frequent switching operations. By adjusting the area of the weapon, help can be provided to the player in specific gameplay situations where the use of certain firearms is restricted or certain firearms are used infrequently. In addition, by adjusting the switching angle, the switching efficiency of other weapons can be improved. In actual applications, real-time dynamic adjustments can be made based on player needs and player mechanics.

In an embodiment of the present disclosure, the main control is a circular control, and the auxiliary controls are fan-shaped controls surrounding the circular control.

The main control is set to a circle, and the other auxiliary controls representing weapon identities are fan-shaped controls surrounding the circular control. This makes it easier for players to quickly switch virtual weapons, thereby improving the weapon switching agility.

An embodiment of the present disclosure further provides an electronic device, which may include a processor, a memory, and a computer program stored in the memory and capable of running on the processor. The computer program, when executed by the processor, implements the following steps:
displaying, in the graphical user interface, a game interface corresponding to a virtual object controlled by the terminal device, wherein a switching control is displayed in the game interface, the switching control includes a main control and at least two auxiliary controls distributed around the main control, the main control is configured to display a weapon identity of a virtual weapon currently used by the virtual object, the at least two auxiliary controls each correspond to a virtual weapon and are configured to display a weapon attribute identity of the corresponding virtual weapon, and the currently used virtual weapon is one of virtual weapons respectively corresponding to the at least two auxiliary controls;
in response to a switching operation for the switching control, determining a target auxiliary control from the at least two auxiliary controls, controlling a virtual weapon corresponding to the target auxiliary control to be switched to the virtual weapon currently used by the virtual character, and controlling the main control to display a weapon identity of the virtual weapon corresponding to the target auxiliary control; and
in response to an attack operation, controlling the virtual object to control the currently used virtual weapon to perform a game action.

In embodiments of the present disclosure, the display of multiple virtual weapons of the virtual character is realized in the game interface through the switching control, and the virtual weapons can be quickly switched through the switching control, thereby improving the weapon switching agility.

In some embodiments, the switching operation includes a touch operation and a release operation for the switching control, and in response to the switching operation for the switching control, determining the target auxiliary control from the at least two auxiliary controls, and controlling the virtual weapon corresponding to the target auxiliary control to be switched to the virtual weapon currently used by the virtual character includes:
in response to the touch operation for the switching control, switching the switching control from a first control state to a second control state for display, wherein when the switching control is in the second control state, the plurality of auxiliary controls are used to display ammunition information and weapon identities of virtual weapons carried by the virtual character;
in response to the release operation for the switching control in the second control state, determining the target auxiliary control from the at least two auxiliary controls according to the release operation; and
controlling the virtual weapon corresponding to the target auxiliary control to be switched to the virtual weapon currently used by the virtual character, and switching the switching control from the second control state to the first control state for display.

In embodiments of the present disclosure, when the touch operation is performed for the switching control, the switching control is switched from the first control state to the second control state, which is convenient for the user to view details of the virtual weapon being carried and in turn facilitates the weapon switching. During the touch phase, the switching control is switched to the second control state, displaying weapon details to assist the user in switching the weapon. During the release phase, the switching control is returned to the first control state, avoiding the switching control occupying excessive interface and improving the user's gaming experience.

In some embodiments, the method further includes:
when the switching control is in the second control state, switching the weapon identity, displayed by the main control, of the virtual weapon currently used by the virtual object to a cancel control; and
in response to the release operation acting on the cancel control, determining to cancel a switching operation for the currently used virtual weapon.

By switching the weapon identity, displayed by the main control, of the virtual weapon currently used by the virtual object to the cancel control and making the release operation act on the cancel control, the virtual weapon switching operation can be canceled, making it easier for the player to adjust the virtual weapon in real time.

In some embodiments, the switching operation further includes a sliding operation, the sliding operation is an operation continuous with the touch operation, the release operation is an operation continuous with the sliding operation, the sliding operation is an operation greater than a preset sliding threshold, and the preset sliding threshold is a minimum sliding distance from a first action position of the touch operation to a second action position responding to the release operation.

In this embodiment, the switching operation is composed of multiple continuous operations, which may include the touch operation, the sliding operation and the release operation. The three operations are performed in the order of touch-sliding-release to realize the switching operation of the switching control. The virtual weapons can be quickly switched through the switching control, which improves the weapon switching agility.

In some embodiments, a preset sliding threshold corresponding to each auxiliary control is configured according to a switching frequency of a virtual weapon corresponding to the auxiliary control.

When a switching frequency of a certain virtual weapon is high, the weapon needs to be switched quickly and its preset sliding distance is short. Conversely, when a switching frequency of a certain virtual weapon is low and below the second preset range, a longer preset sliding distance can be set. Generally, virtual weapons with high switching frequencies are virtual weapons frequently used by the player. Therefore, this process makes it easy for the player to quickly switch to frequently used virtual weapons, further realizing the rapid virtual weapon switching.

In some embodiments, the method further includes:
in response to an attribute adjustment operation for the virtual weapon currently used by the virtual character based on the switching control, adjusting weapon attribute information of the virtual weapon; and
wherein the weapon attribute information includes any one or more of:
preset attribute information of the virtual weapon and attribute information of the virtual weapon after being equipped with a weapon accessory.

In this embodiment, the weapon attribute information of the virtual weapon can also be adjusted through the switching control, so that the user can strengthen the virtual weapon through the weapon attribute information adjustment, which is convenient for the user to better play the game and simplify the operation.

In some embodiments, when the switching operation is a double-click operation, the target auxiliary control is an auxiliary control corresponding to a virtual weapon determined according to a preset weapon switching rule.

By presetting the weapon switching rule, players no longer need to click on the corresponding virtual weapons separately. Instead, they only need to double-click multiple times to switch virtual weapons in sequence, thereby improving the weapon switching smoothness.

In some embodiments, the method further includes:
when the touch operation for the switching control is detected, in response to a touch duration of the touch operation being less than a first time threshold, reloading one or more virtual weapons corresponding to the plurality of auxiliary controls;
in response to the touch duration of the touch operation being greater than a second time threshold, determining to trigger a first adjustment operation for the switching control, wherein the second time threshold is greater than the first time threshold; and
in response to a sliding operation performed continuously after the touch operation when the touch duration of the touch operation is greater than the first time threshold, switching the switching control from the first control state to the second control state for display during the sliding operation, and controlling the virtual weapon corresponding to the target auxiliary control to be switched to the virtual weapon currently used by the virtual character after the release operation.

Through triggering different operations, respectively, by detecting the touch duration of the touch operation for the switching control, the technical problem of occupying a large space caused by implementing different functions through different controls can be avoided. This process can implement multiple different functions through one switching control, thereby improving the utilization rate of the interactive interface.

In some embodiments, the method further includes:
in response to a first adjustment operation for the switching control, controlling the graphical user interface to display a second game screen corresponding to the switching control; and
in response to a second adjustment operation for the second game screen, adjusting an interaction parameter of the switching control according to the second adjustment operation, and generating an adjusted switching control according to the interaction parameter, wherein the interaction parameter includes at least one of: a display parameter or a response parameter.

In some embodiments, the second game screen is overlaid on the game interface with a preset transparency, distribution of other controls of the game interface except the switching control is determined through the second game screen, and the other controls in the game interface are in an unavailable state in the second game screen.

In some embodiments, an exit control for the second game screen is displayed in the second game screen, and the method further includes:
in response to a confirmation operation for the exit control, controlling the graphical user interface to hide the second game screen and display the game interface.

In some embodiments, a save control for adjustment made for the switching control is displayed in the second game screen, and the method further includes:
in response to a confirmation operation for the save control, controlling the graphical user interface to save the adjustment made for the switching control.

In this embodiment, the user's adjustment to the second game screen can be saved through the save control, so that the game screen can be adjusted quickly and efficiently next time.

In some embodiments, a size adjustment control for adjusting a size of the switching control is displayed in the second game screen, and the method further includes:
in response to a size adjustment operation for the size adjustment control in the second game screen, adjusting the size of the switching control according to the size adjustment operation.

In this embodiment, the size adjustment operation of the size adjustment control can adjust the size of the switching control in real time to adapt to different user needs, making it easier for players to adjust the size in real time based on their usage habits, further improving the user's gaming experience. Furthermore, the larger the area of the target auxiliary control, the higher the success rate of switching, which can support more frequent switching operations.

In some embodiments, the method further includes:
in response to a position adjustment operation for the switching control in the second game screen, adjusting a position of the switching control.

In this embodiment, the position of the switching control is adjusted by performing the position adjustment operation for the switching control, so that the user can adjust the position of the switching control based on his or her own usage habits, thereby further improving the user's gaming experience.

In some embodiments, the method further includes:
in response to a click operation for the main control in the second game screen, switching the switching control from a first control state to a second control state for display.

In this embodiment, by clicking on the main control, the switching control can be quickly switched from the first control state to the second control state for display, so that players can timely understand the current usage of virtual weapons and further enhance the user's gaming experience.

In some embodiments, the method further includes:
in response to a rotation operation for the switching control in the second game screen, adjusting angle information of the switching control, and maintaining weapon identities and ammunition information in the plurality of auxiliary controls in a preset direction.

In this embodiment, by adjusting the switching angle, the switching efficiency of other weapons can be improved. In actual application, real-time dynamic adjustment can be made according to the player needs and player mechanism to further enhance the user's gaming experience.

In some embodiments, the method further includes:
in response to a click operation for a first target auxiliary control in the second game screen, highlighting the first target auxiliary control, and switching ammunition information in another auxiliary control to a replacement control; and
in response to a click operation for a target replacement control, exchanging a position of an auxiliary control corresponding to the target replacement control with a position of the first target auxiliary control.

In actual applications, when the user clicks on the target auxiliary control, the target auxiliary control can be selected, and the replacement control can be presented in other unselected auxiliary controls in the switching control. When the user performs a replacement operation for the target replacement control, the position of the target auxiliary control and the position of the auxiliary control corresponding to the target replacement control are exchanged.

In some embodiments, the method further includes:
in response to a click operation for a first target auxiliary control in the second game screen, highlighting an area adjustment reference line of the first target auxiliary control; and
in response to an adjustment operation for the area adjustment reference line, adjusting distribution area of the first target auxiliary control.

The larger the area of the target auxiliary control, the higher the success rate of switching, which can support more frequent switching operations. By adjusting the area of the weapon, help can be provided to the player in specific gameplay situations where the use of certain firearms is restricted or certain firearms are used infrequently. In addition, by adjusting the switching angle, the switching efficiency of other weapons can be improved. In actual applications, real-time dynamic adjustments can be made based on player needs and player mechanics.

In some embodiments, the main control is a circular control, and the auxiliary controls are fan-shaped controls surrounding the circular control.

The main control is set to a circle, and the other auxiliary controls representing weapon identities are fan-shaped controls surrounding the circular control. This makes it easier for players to quickly switch virtual weapons, thereby improving the weapon switching agility.

In embodiments of the present disclosure, the game interface corresponding to the virtual object controlled by the terminal device is displayed in the graphical user interface, and the switching control including the main control and the at least two auxiliary controls distributed around the main control is displayed in the game interface; in response to the switching operation for the switching control, the target auxiliary control is determined from the at least two auxiliary controls, the virtual weapon corresponding to the target auxiliary control is controlled to be switched to the virtual weapon currently used by the virtual character, and the main control is controlled to display the weapon identity of the virtual weapon corresponding to the target auxiliary control; and in response to the attack operation, the virtual object is controlled to control the currently used virtual weapon to perform the game action, thereby realizing the display of multiple virtual weapons of the virtual character in the game interface through the switching control, and the virtual weapons can be quickly switched through the switching control, thereby improving the weapon switching agility.

An embodiment of the present disclosure further provides a computer-readable storage medium having a computer program stored thereon, and the computer program, when executed by a processor, implements the following steps:
displaying, in the graphical user interface, a game interface corresponding to a virtual object controlled by the terminal device, wherein a switching control is displayed in the game interface, the switching control includes a main control and at least two auxiliary controls distributed around the main control, the main control is configured to display a weapon identity of a virtual weapon currently used by the virtual object, the at least two auxiliary controls each correspond to a virtual weapon and are configured to display a weapon attribute identity of the corresponding virtual weapon, and the currently used virtual weapon is one of virtual weapons respectively corresponding to the at least two auxiliary controls;
in response to a switching operation for the switching control, determining a target auxiliary control from the at least two auxiliary controls, controlling a virtual weapon corresponding to the target auxiliary control to be switched to the virtual weapon currently used by the virtual character, and controlling the main control to display a weapon identity of the virtual weapon corresponding to the target auxiliary control; and
in response to an attack operation, controlling the virtual object to control the currently used virtual weapon to perform a game action.

In embodiments of the present disclosure, the display of multiple virtual weapons of the virtual character is realized in the game interface through the switching control, and the virtual weapons can be quickly switched through the switching control, thereby improving the weapon switching agility.

In some embodiments, the switching operation includes a touch operation and a release operation for the switching control, and in response to the switching operation for the switching control, determining the target auxiliary control from the at least two auxiliary controls, and controlling the virtual weapon corresponding to the target auxiliary control to be switched to the virtual weapon currently used by the virtual character includes:
in response to the touch operation for the switching control, switching the switching control from a first control state to a second control state for display, wherein when the switching control is in the second control state, the plurality of auxiliary controls are used to display ammunition information and weapon identities of virtual weapons carried by the virtual character;
in response to the release operation for the switching control in the second control state, determining the target auxiliary control from the at least two auxiliary controls according to the release operation; and
controlling the virtual weapon corresponding to the target auxiliary control to be switched to the virtual weapon currently used by the virtual character, and switching the switching control from the second control state to the first control state for display.

In embodiments of the present disclosure, when the touch operation is performed for the switching control, the switching control is switched from the first control state to the second control state, which is convenient for the user to view details of the virtual weapon being carried and in turn facilitates the weapon switching. During the touch phase, the switching control is switched to the second control state, displaying weapon details to assist the user in switching the weapon. During the release phase, the switching control is returned to the first control state, avoiding the switching control occupying excessive interface and improving the user's gaming experience.

In some embodiments, the method further includes:
when the switching control is in the second control state, switching the weapon identity, displayed by the main control, of the virtual weapon currently used by the virtual object to a cancel control; and
in response to the release operation acting on the cancel control, determining to cancel a switching operation for the currently used virtual weapon.

By switching the weapon identity, displayed by the main control, of the virtual weapon currently used by the virtual object to the cancel control and making the release operation act on the cancel control, the virtual weapon switching operation can be canceled, making it easier for the player to adjust the virtual weapon in real time.

In some embodiments, the switching operation further includes a sliding operation, the sliding operation is an operation continuous with the touch operation, the release operation is an operation continuous with the sliding operation, the sliding operation is an operation greater than a preset sliding threshold, and the preset sliding threshold is a minimum sliding distance from a first action position of the touch operation to a second action position responding to the release operation.

In this embodiment, the switching operation is composed of multiple continuous operations, which may include the touch operation, the sliding operation and the release operation. The three operations are performed in the order of touch-sliding-release to realize the switching operation of the switching control. The virtual weapons can be quickly switched through the switching control, which improves the weapon switching agility.

In some embodiments, a preset sliding threshold corresponding to each auxiliary control is configured according to a switching frequency of a virtual weapon corresponding to the auxiliary control.

When a switching frequency of a certain virtual weapon is high, the weapon needs to be switched quickly and its preset sliding distance is short. Conversely, when a switching frequency of a certain virtual weapon is low and below the second preset range, a longer preset sliding distance can be set. Generally, virtual weapons with high switching frequencies are virtual weapons frequently used by the player. Therefore, this process makes it easy for the player to quickly switch to frequently used virtual weapons, further realizing the rapid virtual weapon switching.

In some embodiments, the method further includes:
in response to an attribute adjustment operation for the virtual weapon currently used by the virtual character based on the switching control, adjusting weapon attribute information of the virtual weapon; and
wherein the weapon attribute information includes any one or more of:
preset attribute information of the virtual weapon and attribute information of the virtual weapon after being equipped with a weapon accessory.

In this embodiment, the weapon attribute information of the virtual weapon can also be adjusted through the switching control, so that the user can strengthen the virtual weapon through the weapon attribute information adjustment, which is convenient for the user to better play the game and simplify the operation.

In some embodiments, when the switching operation is a double-click operation, the target auxiliary control is an auxiliary control corresponding to a virtual weapon determined according to a preset weapon switching rule.

By presetting the weapon switching rule, players no longer need to click on the corresponding virtual weapons separately. Instead, they only need to double-click multiple times to switch virtual weapons in sequence, thereby improving the weapon switching smoothness.

In some embodiments, the method further includes:
when the touch operation for the switching control is detected, in response to a touch duration of the touch operation being less than a first time threshold, reloading one or more virtual weapons corresponding to the plurality of auxiliary controls; in response to the touch duration of the touch operation being greater than a second time threshold, determining to trigger a first adjustment operation for the switching control, wherein the second time threshold is greater than the first time threshold; and in response to a sliding operation performed continuously after the touch operation when the touch duration of the touch operation is greater than the first time threshold, switching the switching control from the first control state to the second control state for display during the sliding operation, and controlling the virtual weapon corresponding to the target auxiliary control to be switched to the virtual weapon currently used by the virtual character after the release operation.

Through triggering different operations, respectively, by detecting the touch duration of the touch operation for the switching control, the technical problem of occupying a large space caused by implementing different functions through different controls can be avoided. This process can implement multiple different functions through one switching control, thereby improving the utilization rate of the interactive interface.

In some embodiments, the method further includes: in response to a first adjustment operation for the switching control, controlling the graphical user interface to display a second game screen corresponding to the switching control; and in response to a second adjustment operation for the second game screen, adjusting an interaction parameter of the switching control according to the second adjustment operation, and generating an adjusted switching control according to the interaction parameter, wherein the interaction parameter includes at least one of: a display parameter or a response parameter.

In some embodiments, the second game screen is overlaid on the game interface with a preset transparency, distribution of other controls of the game interface except the switching control is determined through the second game screen, and the other controls in the game interface are in an unavailable state in the second game screen.

In some embodiments, an exit control for the second game screen is displayed in the second game screen, and the method further includes:
in response to a confirmation operation for the exit control, controlling the graphical user interface to hide the second game screen and display the game interface.

In some embodiments, a save control for adjustment made for the switching control is displayed in the second game screen, and the method further includes:
in response to a confirmation operation for the save control, controlling the graphical user interface to save the adjustment made for the switching control.

In this embodiment, the user's adjustment to the second game screen can be saved through the save control, so that the game screen can be adjusted quickly and efficiently next time.

In some embodiments, a size adjustment control for adjusting a size of the switching control is displayed in the second game screen, and the method further includes:
in response to a size adjustment operation for the size adjustment control in the second game screen, adjusting the size of the switching control according to the size adjustment operation.

In this embodiment, the size adjustment operation of the size adjustment control can adjust the size of the switching control in real time to adapt to different user needs, making it easier for players to adjust the size in real time based on their usage habits, further improving the user's gaming experience. Furthermore, the larger the area of the target auxiliary control, the higher the success rate of switching, which can support more frequent switching operations.

In some embodiments, the method further includes:
in response to a position adjustment operation for the switching control in the second game screen, adjusting a position of the switching control.

In this embodiment, the position of the switching control is adjusted by performing the position adjustment operation for the switching control, so that the user can adjust the position of the switching control based on his or her own usage habits, thereby further improving the user's gaming experience.

In some embodiments, the method further includes:
in response to a click operation for the main control in the second game screen, switching the switching control from a first control state to a second control state for display.

In this embodiment, by clicking on the main control, the switching control can be quickly switched from the first control state to the second control state for display, so that players can timely understand the current usage of virtual weapons and further enhance the user's gaming experience.

In some embodiments, the method further includes:
in response to a rotation operation for the switching control in the second game screen, adjusting angle information of the switching control, and maintaining weapon identities and ammunition information in the plurality of auxiliary controls in a preset direction.

In this embodiment, by adjusting the switching angle, the switching efficiency of other weapons can be improved. In actual application, real-time dynamic adjustment can be made according to the player needs and player mechanism to further enhance the user's gaming experience.

In some embodiments, the method further includes:
in response to a click operation for a first target auxiliary control in the second game screen, highlighting the first target auxiliary control, and switching ammunition information in another auxiliary control to a replacement control; and in response to a click operation for a target replacement control, exchanging a position of an auxiliary control corresponding to the target replacement control with a position of the first target auxiliary control.

In actual applications, when the user clicks on the target auxiliary control, the target auxiliary control can be selected, and the replacement control can be presented in other unselected auxiliary controls in the switching control. When the user performs a replacement operation for the target replacement control, the position of the target auxiliary control and the position of the auxiliary control corresponding to the target replacement control are exchanged.

In some embodiments, the method further includes:
in response to a click operation for a first target auxiliary control in the second game screen, highlighting an area adjustment reference line of the first target auxiliary control; and in response to the click operation for the first target auxiliary control and in response to an adjustment operation for the area adjustment reference line, adjusting distribution area of the first target auxiliary control.

The larger the area of the target auxiliary control, the higher the success rate of switching, which can support more frequent switching operations. By adjusting the area of the weapon, help can be provided to the player in specific gameplay situations where the use of certain firearms is restricted or certain firearms are used infrequently. In addition, by adjusting the switching angle, the switching efficiency of other weapons can be improved. In actual applications, real-time dynamic adjustments can be made based on player needs and player mechanics.

In some embodiments, the main control is a circular control, and the auxiliary controls are fan-shaped controls surrounding the circular control.

The main control is set to a circle, and the other auxiliary controls representing weapon identities are fan-shaped controls surrounding the circular control. This makes it easier for players to quickly switch virtual weapons, thereby improving the weapon switching agility.

In embodiments of the present disclosure, the game interface corresponding to the virtual object controlled by the terminal device is displayed in the graphical user interface, and the switching control including the main control and the at least two auxiliary controls distributed around the main control is displayed in the game interface; in response to the switching operation for the switching control, the target auxiliary control is determined from the at least two auxiliary controls, the virtual weapon corresponding to the target auxiliary control is controlled to be switched to the virtual weapon currently used by the virtual character, and the main control is controlled to display the weapon identity of the virtual weapon corresponding to the target auxiliary control; and in response to the attack operation, the virtual object is controlled to control the currently used virtual weapon to perform the game action, thereby realizing the display of multiple virtual weapons of the virtual character in the game interface through the switching control, and the virtual weapons can be quickly switched through the switching control, thereby improving the weapon switching agility.

For the device embodiments, since it is basically similar to the method embodiments, the description is relatively simple, and the relevant parts can be referred to the description of the method embodiments.

Various embodiments in the present specification are described in a progressive manner, each embodiment focuses on differences from other embodiments, and the identical or similar parts between the various embodiments can be referred to each other.

A person skilled in the art should understand that the embodiments of the present disclosure may be provided as a method, a device or a computer program product. Thus, the embodiments of the present disclosure may adopt forms of complete hardware embodiments, complete software embodiments or embodiments integrating software and hardware. Moreover, the embodiments of the present disclosure may adopt the form of a computer program product implemented on one or more computer available storage media (including, but not limited to, a disk memory, a CD-ROM, an optical memory and the like) containing computer available program codes.

The embodiments of the present disclosure are described with reference to flowcharts and/or block diagrams of the method, the terminal device (system) and the computer program product according to the embodiments of the present disclosure. It is to be understood that each flow and/or block in the flowcharts and/or the block diagrams and a combination of the flows and/or the blocks in the flowcharts and/or the block diagrams may be implemented by computer program instructions. These computer program instructions may be provided for a general computer, a dedicated computer, an embedded processor or processors of other programmable data processing terminal devices to generate a machine, so that an apparatus for achieving functions designated in one or more flows of the flowcharts and/or one or more blocks of the block diagrams is generated via instructions executed by the computers or the processors of the other programmable data processing terminal devices.

These computer program instructions may also be stored in a computer readable memory capable of guiding the computers or the other programmable data processing terminal devices to work in a specific mode, so that a manufactured product including an instruction apparatus is generated via the instructions stored in the computer readable memory, and the instruction apparatus achieves the functions designated in one or more flows of the flowcharts and/or one or more blocks of the block diagrams.

These computer program instructions may also be loaded to the computers or the other programmable data processing terminal devices, so that processing implemented by the computers is generated by executing a series of operation steps on the computers or the other programmable terminal devices, and therefore the instructions executed on the computers or the other programmable terminal devices provide a step of achieving the functions designated in one or more flows of the flowcharts and/or one or more blocks of the block diagrams.

While preferred embodiments of the embodiments of the present disclosure has been described, those skilled in the art can make additional changes and modifications to the embodiments once knowing a basic creativity concept. Therefore, the appended claims are intended to be interpreted as including the preferred embodiments and all the changes and modifications falling within the scope of the embodiments of the present disclosure.

Finally, it is also to be noted that relational terms such as first and second are used merely to distinguish one entity or operation from another entity or operation herein, and do not necessarily require or imply the existence of any such actual relationship or order between these entities or operations. Moreover, the terms “include”, “contain” or any other variations thereof are intended to cover a non-exclusive inclusion, such that a process, method, article or terminal device including a series of elements not only includes those elements, but also includes those elements that are not explicitly listed, or includes elements inherent to such a process, method, article or terminal device. Under the condition of no more limitations, it is not excluded that additional identical elements exist in the process, method, article or terminal device including elements defined by a sentence “including a . . . ”.

The above is a detailed description of the method and device for switching the weapon in the virtual game provided herein. The principle and implementation manner of the present disclosure are described in the specific examples herein. The description of the embodiments is only for helping to understand the method of the present disclosure and its core ideas. Meanwhile, for those of ordinary skill in the art, according to the idea of the present disclosure, there will be changes in specific implementation manners and application scopes. In conclusion, the content of the description should not be taken as limiting the present disclosure.

1. A method for switching a weapon in a virtual game, wherein a graphical user interface is provided by a terminal device, and the method comprises:
displaying, in the graphical user interface, a game interface corresponding to a virtual character controlled by the terminal device, wherein a switching control is displayed in the game interface, the switching control comprises a main control and at least two auxiliary controls distributed around the main control, the main control is configured to display a weapon identity of a virtual weapon currently used by the virtual character, the at least two auxiliary controls each correspond to a virtual weapon and are configured to display a weapon attribute identity of the corresponding virtual weapon, and the currently used virtual weapon is one of virtual weapons respectively corresponding to the at least two auxiliary controls;
in response to a switching operation for the switching control, determining a target auxiliary control from the at least two auxiliary controls, controlling a virtual weapon corresponding to the target auxiliary control to be switched to the virtual weapon currently used by the virtual character, and controlling the main control to display a weapon identity of the virtual weapon corresponding to the target auxiliary control; and
in response to an attack operation, controlling the virtual character to control the currently used virtual weapon to perform a game action.

2. The method according to claim 1, wherein the switching operation comprises a touch operation and a release operation for the switching control, and in response to the switching operation for the switching control, determining the target auxiliary control from the at least two auxiliary controls, and controlling the virtual weapon corresponding to the target auxiliary control to be switched to the virtual weapon currently used by the virtual character comprises:
in response to the touch operation for the switching control, switching the switching control from a first control state to a second control sate for display, wherein in response to determining that the switching control is in the second control state, the at least two auxiliary controls are used to display ammunition information and weapon identities of virtual weapons carried by the virtual character;
in response to the release operation for the switching control in the second control state, determining the target auxiliary control from the at least two auxiliary controls according to the release operation; and
controlling the virtual weapon corresponding to the target auxiliary control to be switched to the virtual weapon currently used by the virtual character, and switching the switching control from the second control state to the first control state for display.

3. The method according to claim 2, further comprising:
in response to determining that the switching control is in the second control state, switching the weapon identity, displayed by the main control, of the virtual weapon currently used by the virtual character to a cancel control; and
in response to the release operation acting on the cancel control, determining to cancel a switching operation for the currently used virtual weapon.

4. The method according to claim 2, wherein the switching operation further comprises a sliding operation, the sliding operation is an operation continuous with the touch operation, the release operation is an operation continuous with the sliding operation, the sliding operation is an operation greater than a preset sliding threshold, and the preset sliding threshold is a minimum sliding distance from a first action position of the touch operation to a second action position responding to the release operation.

5. The method according to claim 4, wherein a preset sliding threshold corresponding to each auxiliary control is configured according to a switching frequency of a virtual weapon corresponding to the auxiliary control.

6. The method according to claim 1, further comprising:
in response to an attribute adjustment operation for the virtual weapon currently used by the virtual character based on the switching control, adjusting weapon attribute information of the virtual weapon; and
wherein the weapon attribute information comprises any one or more of:
preset attribute information of the virtual weapon and attribute information of the virtual weapon after being equipped with a weapon accessory.

7. The method according to claim 1, wherein when the switching operation is a double-click operation, the target auxiliary control is an auxiliary control corresponding to a virtual weapon determined according to a preset weapon switching rule.

8. The method according to claim 2, further comprising:
in response to determining that the touch operation for the switching control is detected, and a touch duration of the touch operation is less than a first time threshold, reloading one or more virtual weapons corresponding to the at least two auxiliary controls;
in response to the touch duration of the touch operation being greater than a second time threshold, determining to trigger a first adjustment operation for the switching control, wherein the second time threshold is greater than the first time threshold; and
in response to a sliding operation performed continuously after the touch operation whose the touch operation is greater than the first time threshold, switching the switching control from the first control state to the second control state for display during the sliding operation, and controlling the virtual weapon corresponding to the target auxiliary control to be switched to the virtual weapon currently used by the virtual character after the release operation.

9. The method according to claim 1, further comprising:
in response to a first adjustment operation for the switching control, controlling the graphical user interface to display a second game screen corresponding to the switching control; and
in response to a second adjustment operation for the second game screen, adjusting an interaction parameter of the switching control according to the second adjustment operation, and generating an adjusted switching control according to the interaction parameter, wherein the interaction parameter comprises at least one of: a display parameter or a response parameter.

10. The method according to claim 9, wherein the second game screen is overlaid on the game interface with a preset transparency, distribution of other controls of the game interface except the switching control is determined through the second game screen, and the other controls in the game interface are in an unavailable state in the second game screen.

11. The method according to claim 9, wherein an exit control for the second game screen is displayed in the second game screen, and the method further comprises:
in response to a confirmation operation for the exit control, controlling the graphical user interface to hide the second game screen and display the game interface.

12. The method according to claim 9, wherein a save control for adjustment made for the switching control is displayed in the second game screen, and the method further comprises:
in response to a confirmation operation for the save control, controlling the graphical user interface to save the adjustment made for the switching control.

13. The method according to claim 9, wherein a size adjustment control for adjusting a size of the switching control is displayed in the second game screen, and the method further comprises:
in response to a size adjustment operation for the size adjustment control in the second game screen, adjusting the size of the switching control according to the size adjustment operation.

14. The method according to claim 9, further comprising:
in response to a position adjustment operation for the switching control in the second game screen, adjusting a position of the switching control.

15. The method according to claim 9, further comprising:
in response to a click operation for the main control in the second game screen, switching the switching control from a first control state to a second control state for display.

16. The method according to claim 15, further comprising:
in response to a rotation operation for the switching control in the second game screen, adjusting angle information of the switching control, and maintaining weapon identities and ammunition information in the at least two auxiliary controls in a preset direction.

17. The method according to claim 15, further comprising:
in response to a click operation for a first target auxiliary control in the second game screen, highlighting the first target auxiliary control, and switching ammunition information in another auxiliary control to a replacement control; and
in response to a click operation for a target replacement control, exchanging a position of an auxiliary control corresponding to the target replacement control with a position of the first target auxiliary control.

18. The method according to claim 15, further comprising:
in response to a click operation for a first target auxiliary control in the second game screen, highlighting an area adjustment reference line of the first target auxiliary control; and
in in response to an adjustment operation for the area adjustment reference line, adjusting a distribution area of the first target auxiliary control.

19. The method according to claim 1, wherein the main control is a circular control, and the auxiliary controls are fan-shaped controls surrounding the circular control.

20. (canceled)

21. An electronic device, comprising a processor, a memory, and a computer program stored in the memory and capable of running on the processor, wherein the computer program, when executed by the processor, implements the following operations:
displaying, in a graphical user interface provided by the electronic device, a game interface corresponding to a virtual character controlled by the electronic device, wherein a switching control is displayed in the game interface, the switching control comprises a main control and at least two auxiliary controls distributed around the main control, the main control is configured to display a weapon identity of a virtual weapon currently used by the virtual character, the at least two auxiliary controls each correspond to a virtual weapon and are configured to display a weapon attribute identity of the corresponding virtual weapon, and the currently used virtual weapon is one of virtual weapons respectively corresponding to the at least two auxiliary controls;
in response to a switching operation for the switching control, determining a target auxiliary control from the at least two auxiliary controls, controlling a virtual weapon corresponding to the target auxiliary control to be switched to the virtual weapon currently used by the virtual character, and controlling the main control to display a weapon identity of the virtual weapon corresponding to the target auxiliary control; and
in response to an attack operation, controlling the virtual character to control the currently used virtual weapon to perform a game action.

22. (canceled)
